(19) United States
(12) Patent Application Publication
(10) Pub. No.: US 2012/0180531 A1
(43) Pub. Date: Jul. 19, 2012

(54) GLASS FURNACE, IN PARTICULAR FOR CLEAR OR ULTRA-CLEAR GLASS, WITH A REDUCTION IN THE PRIMARY RECIRCULATION

(75) Inventors: Wolf Stefan Kuhn, Fontenay Le Vicomte (FR); Samir Tabloul, Montrouge (FR)

(73) Assignee: Fives Stein, Ris Orangis (FR)

(21) Appl. No.: 13/498,647

(22) PCT Filed: Sep. 28, 2010
(86) PCT No.: PCT/IB2010/054351

§ 371 Date: Mar. 28, 2012

(30) Foreign Application Priority Data
Sep. 30, 2009 (FR) 0904657

(51) Int. Cl. C03B 5/185; C03B 5/182

(52) U.S. Cl. 65/347

(57) ABSTRACT

The invention relates to a glass furnace for heating and melting materials to be vitrified, in which two loops (B1, B2) for recirculating molten glass are formed in the bath between a hotter central area (I) of the furnace and the entrance and exit at a lower temperature, respectively. The furnace comprises a means (X) for slowing the flow of molten glass in the primary recirculation loop (B1).

The invention relates to a glass furnace with a double recirculation loop for heating, melting and refining materials to be vitrified, the furnace being of the type which comprises:
an inlet for the raw materials,
a superstructure provided with heating means,
a tank containing a bath of molten glass on which a blanket of raw materials floats from the inlet to a point a certain distance away inside the furnace, and
an outlet through which the molten glass is discharged.

The invention relates more particularly, but not exclusively, to a furnace for clear or ultra-clear glass.

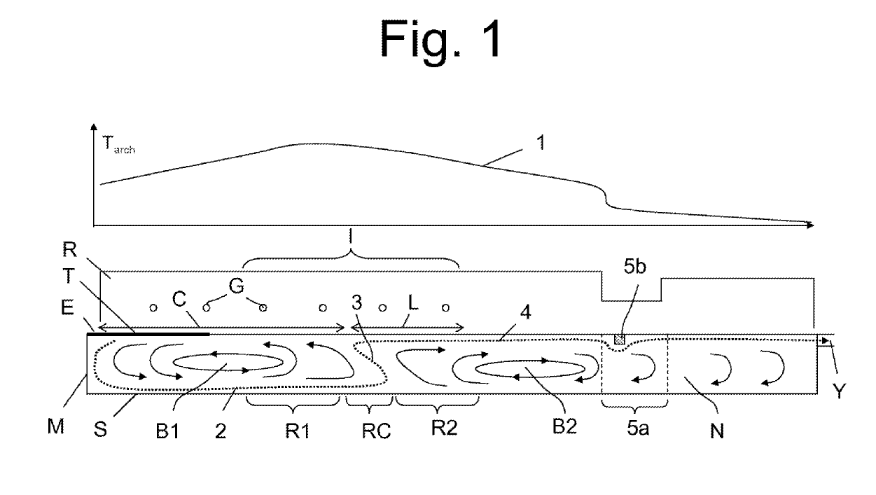

The diagram in FIG. 1 of the appended drawings shows a conventional float glass furnace with an inlet E for the raw materials, a superstructure R provided with burners G, a tank M whose floor S supports a bath N of molten glass on which a blanket T of raw materials floats from the inlet, and an outlet Y. Above the furnace, the variation of the temperature T_{arch} of the hot surface of the arch of the superstructure R along the length of the furnace is shown on the vertical axis in FIG. 1, and is illustrated by the curve 1 whose peak is located in the central region I of the furnace.

Two liquid glass recirculation loops B1, B2 are formed in the bath between a hotter central region I of the furnace and, respectively, the inlet E and the outlet Y, which are at a lower temperature. As shown in FIG. 1, the recirculation in the primary loop B1 takes place in an anticlockwise direction: the glass at the surface flows from the region I toward the inlet E, descends toward the floor and returns in the lower part of the bath toward the central region I, where it rises again toward the surface. The recirculation in the secondary loop B2 takes place in the opposite direction, in other words in the clockwise direction. These two recirculation loops have an effect on the main flow of the furnace output. They modify the shape and duration of the main flow as a function of their intensity.

The shortest path of the main flow, corresponding to the shortest residence time, which is critical for the quality of the glass extracted from the furnace, is shown schematically by the dashed curve 2 along which the glass moves from a point near the inlet to the vicinity of the floor S, then rises again along a more or less sinuous path 3 between the two recirculation loops to follow a trajectory 4 in the vicinity of the upper level of the bath toward the outlet Y. The rise 3 takes place in a central upward flow region RC contained between the two loops B1, B2 and their upward flow regions R1 and R2. The point of return of the glass flow to the surface of the bath marks the surface separation of the upward flows R1 and RC. The distance between the furnace inlet and this point of return defines the length C shown in FIG. 1, representing the length of the loop B1. It can be determined experimentally or by numerical simulation. The quality of the refining of the glass is determined by the initial part of the trajectory 4. In this initial part, the glass is held at a temperature greater than the refining temperature (approximately 1450° C. for soda-lime glass) for a specified time. The residence time in the initial part of the trajectory 4 is therefore a factor which determines the quality of the glass produced. This residence time is determined by the length L of the region at a temperature greater than approximately 1450° C. for soda-lime glass, and by the speed of flow of the glass. The speed of flow of the glass is dependent on the output achieved at the furnace outlet and on the intensity of the recirculation B2.

The aim is therefore to maximize the “refining” residence time to improve the quality of the glass, or increase the furnace output at constant quality. The extension of the residence time can be achieved by slowing the secondary recirculation, which also enables the furnace consumption to be reduced. Thus, a constriction of the furnace width, called a corset 5a, has been provided in recent years in float glass furnaces. In this corset 5a it is also possible to use a water-cooled dam 5b to slow the recirculation further.

Another known method of extending the “refining” residence time is to displace the central upward flow region RC by modifying the longitudinal combustion temperature profile. Thus, the hottest point of the profile 1 is displaced toward the furnace inlet. However, the hydrodynamic competition between the two recirculation loops B1 and B2 sets limits on this displacement.

The prior art solutions mentioned above are relatively satisfactory for ordinary glass, but are inadequate for ultra-clear glass.

Three major problems arise in the melting of ultra-clear glass:

1. Degradation of the refining quality of the glass.

2. Increased corrosion of the inner walls of the tank M.

3. Increased temperature at the floor, with a risk of increased corrosion.

To overcome these problems, manufacturers are forced to reduce output by 10% to 15% when changing from clear glass to ultra-clear glass in a float glass furnace.

In order to maintain the upward flow positions and the refining time, use is sometimes made of an array of bubblers or an anti-backflow wall placed on the floor in the upward flow region RC. However, the bubblers reinforce the circulation and increase the floor temperature, which is already critical for ultra-clear glass. Corrosion is also a critical point for a wall.

In order to resolve the problem of high furnace floor temperature for ultra-clear glass, and in order to reduce this temperature, a greater depth h of the molten glass bath is commonly chosen. This brings the depth of the tank to about 1.4 to 1.8 m. However, an increase in depth promotes recirculation, notably for ultra-clear glass. As a general rule, an increase in the intensity of recirculation reduces the shortest residence time in melting furnaces, in spite of an increase in the glass volume. The increased cost of the tank and the longer time required to change the color of the glass are other disadvantages resulting from increased depth.

Another method known to those skilled in the art for limiting the floor temperature is that of reducing the thermal insulation in order to promote the dissipation of heat and limit the temperature.

The primary object of the invention is to provide a glass furnace with a double recirculation loop which does not have, or is less subject to, the aforementioned drawbacks, and which, notably, enables high refining quality to be achieved, not only for ultra-clear glass but also for clear and ordinary glass.

According to the invention, a glass furnace of the type defined above, wherein two recirculation loops of molten glass are formed in the tank between a hotter central region of the furnace and, respectively, the inlet and the outlet which are at a lower temperature, is characterized in that it includes a means for slowing the molten glass flow rate in the primary recirculation loop, which can reduce the length of this loop.

By reducing the length of the primary recirculation loop it is possible to extend the refining region L for a given furnace length, in order to improve the quality of the glass.

An increase in the output of a given furnace results in an extension of the loop B1. The invention enables this extension to be reduced in order to maintain the length of the glass refining time.

In an exemplary embodiment of the invention, the means for slowing the flow rate in the primary recirculation loop B1 comprises a reduction in the average depth of the tank in the region of the recirculation loop B1 relative to the depth in the central upward flow region of the glass.

In another exemplary embodiment, the means for slowing the flow rate in the primary recirculation loop B1 comprises a heat input means for heating the return glass circulating at the level of the floor.

Preferably, the means for slowing the flow rate in the primary recirculation loop comprises an inclination of the floor substantially from the inlet toward the interior of the furnace, over a distance of 20-100%, and preferably 50%, of the length of the primary recirculation loop represented by the length C, in such a way that the depth of the floor increases from the furnace inlet toward the interior. The distance of 50% is substantially equal to the length of the blanket.

The decrease in the depth of the floor from the interior of the furnace toward the raw materials inlet is advantageously provided in a discontinuous way, particularly by means of successive steps, each having a small height, notably of less than 25 cm.

If the variation in depth is achieved by means of steps, the steps may be chamfered.

In a variant, the decrease in the depth of the floor from the interior of the furnace toward the raw materials inlet may be continuous, along an inclined plane.

Advantageously, the slowing means is formed by a continuous or stepped inclination of the floor, extending substantially from the inlet toward the interior of the furnace, over a distance substantially equal to the length of the blanket.

In another variant, the decrease in the depth of the floor from the interior of the furnace toward the raw materials inlet is provided by the presence of one or more obstacles placed on the floor, notably one or more transverse projections.

Electric heating using conventional electrodes is advantageously provided in the molten glass bath under the blanket.

In addition to the arrangements described above, the invention is composed of a number of other arrangements which are described more fully below with regard to an exemplary embodiment described with reference to the appended drawings, although this embodiment is not limiting in any way. In these drawings:

FIG. 1 is a schematic vertical section through a conventional float glass furnace.

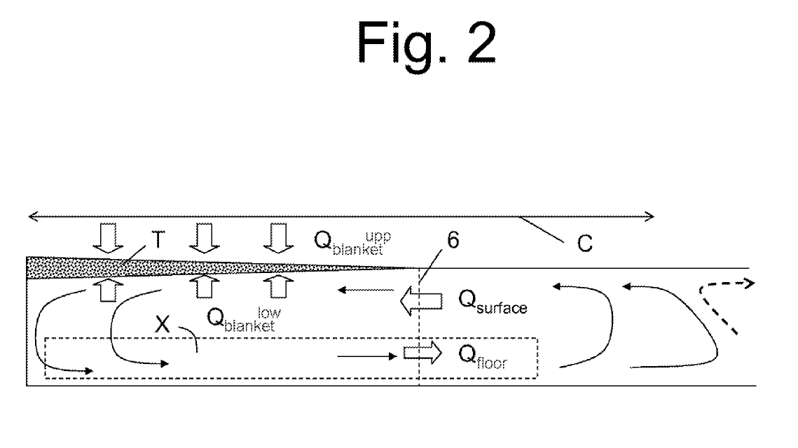

FIG. 2 is a partial schematic vertical section through the blanket and the melting bath for the establishment of a simplified local heat balance.

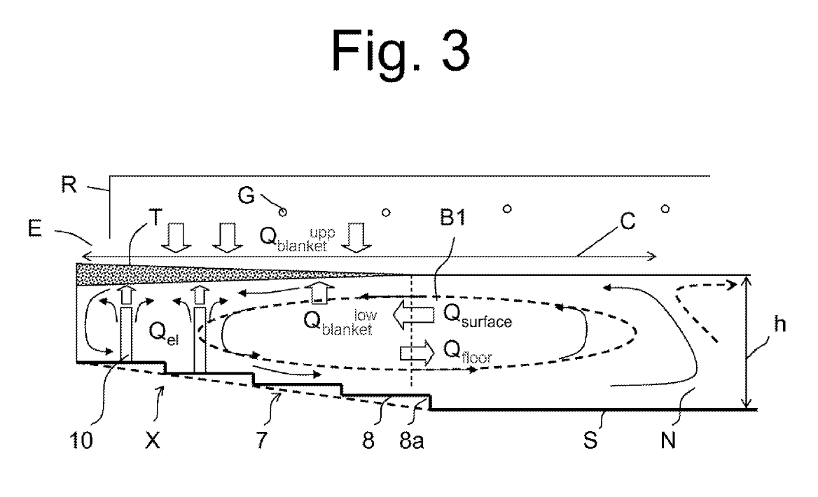

FIG. 3 is a partial schematic vertical section through a furnace according to the invention.

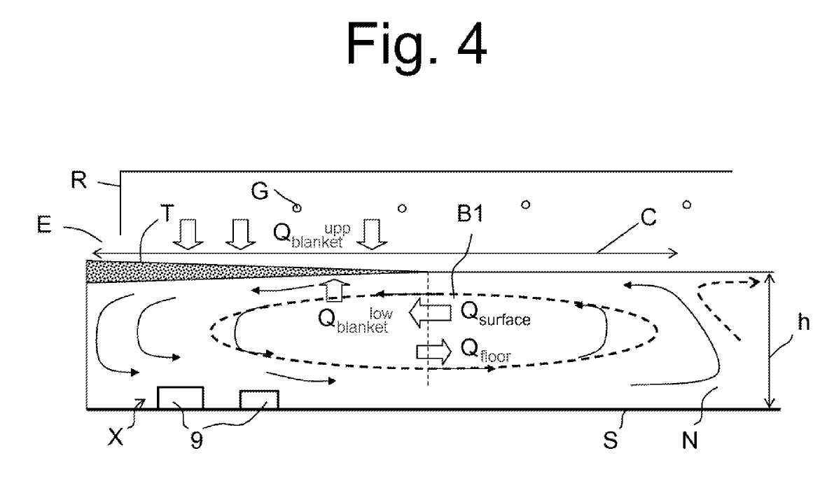

FIG. 4 is a partial schematic vertical section through a variant of the furnace according to the invention, and

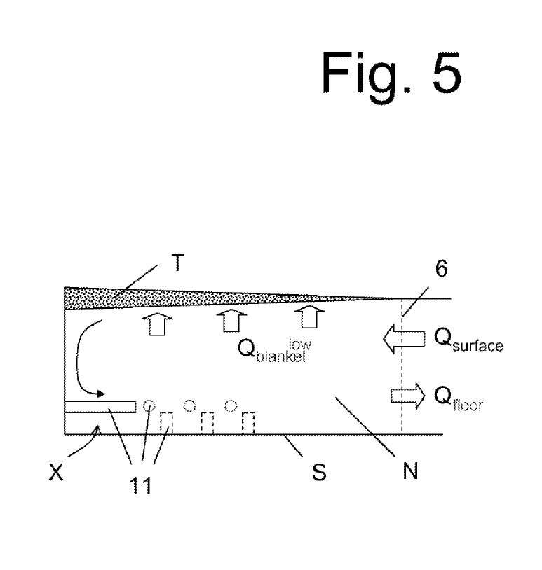

FIG. 5 is a partial schematic vertical section through a furnace according to the invention, showing a new variant embodiment of the invention comprising a heat input from electrodes to the return glass.

In the diagram of FIG. 2, it can be seen that the total energy Q_{blanket} for melting the blanket T is supplied as follows:
directly to the upper surface of the blanket by the combustion radiation, in the form Q_{blanket}^{upp},
and also indirectly, by conduction and convection of the glass under the lower surface of the blanket, as denoted by the expression Q_{blanket}^{low},
   and therefore we have the relation:

Q_{blanket}=Q_{blanket}^{upp}+Q_{blanket}^{low}

The ratio Q_{blanket}^{low}/Q_{blanket} is difficult to determine either by measurement or by modeling, but it is somewhat less than 50%.

The heat is supplied to the lower surface of the blanket by conduction and convection, and causes the glass under the blanket to cool. The glass at the surface imparts a certain quantity of heat which is then absorbed by the lower surface of the blanket.

An equilibrium is established between the absorption by the blanket and the application of heat by the recirculation of the glass, in accordance with the conservation of heat flux:

Q_{blanket}^{low}=ΔQ_{rec},

a relation in which ΔQ_{rec} is equal to the loss of energy from the glass. This loss of energy is equal to the difference between the energy of the glass entering a bath region under the blanket T and the energy of the glass leaving this region, this movement taking place as a result of the recirculation. The region under the blanket taken into consideration for our simplified local heat balance is delimited by an imaginary boundary 6. Clearly, the heat losses from the walls should also be allowed for in the heat balance of the delimited region. The glass near the surface passes through the boundary 6 from right to left in FIG. 2, with an energy of Q_{surface}. It is cooled under the blanket T, and then descends toward the floor and re-emerges from left to right with an energy Q_{floor}.

This can be described thus:

ΔQ_{rec}=Q_{surface}−Q_{floor},

where
Q_{surface} is equal to the energy of the glass entering the region under the blanket T;
Q_{floor} is equal to the energy of the glass leaving this region, the difference corresponding to the temperature drop of the recirculating glass.

This energy difference can also be expressed by the relation

ΔQ_{rec}=\dot{m}·Cₚ·ΔT,

where
\dot{m} is the mass flow rate of the glass in the primary recirculation loop B1,
cₚ is the heat capacity or specific heat of the glass,
ΔT is the temperature difference between the currents entering and leaving the region under the blanket.

The exact quantities of the heat flux of the glass by convection can theoretically be calculated by integration of the flow profiles and the temperature fields in the plane of the imaginary boundary 6, which is omitted here for the sake of clarity.

Since the glass flow rate caused by the melting of the blanket is small compared with the recirculation flow rate, it is disregarded in the following text, in order to simplify the description.

According to the invention, the flow rate \dot{m} is decreased by a means for slowing the glass recirculation.

The preceding formula can be rewritten thus:

\dot{m}=ΔQ_{rec}/Cₚ·ΔT

This formula shows that a decrease in the recirculation flow rate caused by a means for the geometrical slowing of the flow according to the invention can have two results:
The value of ΔQ_{rec} decreases, leading to a decrease in the speed of the glass under the blanket, leading to a reduction in the heat flux Q_{blanket}^{low};
The value ΔT increases, leading to a decrease in the glass temperature under the blanket, such that the glass sinks toward the floor.

In practice, both of these phenomena combine equally with the heat transfer mechanism in the blanket, resulting in the new value Q_{blanket}^{low}.

An example of a detailed description of the complexity of the melting of a blanket is provided in “Mathematical simulation in glass technology”, Springer 2002, edited by D. Krause and H. Loch, in Chapter 2.2, on pages 73-125. A simplified description of these phenomena is provided below.

The quantity of energy Q_{blanket}^{low} absorbed by the lower surface of the blanket T depends, in a complex way, on the heat flux by conduction and convection of the glass directly below the blanket. The contribution of convection as compared with conduction is not initially known. The thermal conduction of the glass can be represented by an effective conduction according to the Rosseland approximation, which incorporates the contribution of radiation into the conduction. Clear glass, and notably ultra-clear glass, have very high values of this effective conduction, and therefore a high heat flux in the presence of thermal gradients. It is therefore essential to check whether the convection of the glass also plays an important part in the transfer of energy under the blanket.

The intensity of the convection can be expressed by the Péclet number Pe, which represents the ratio between the convection heat flux and the conduction heat flux:

Pe=v·L_{char}/α

where v denotes the mean speed of the incoming glass flow under the blanket T, and L_{char} denotes a characteristic length of the system, in this case the length of travel of the glass flow under the blanket.

α denotes the thermal diffusivity, which is proportional to the conductivity (α=effective conductivity/density×cₚ) and depends on the material, which in this case is the glass, and is high for clear or ultra-clear glass. It is almost impossible to modify this parameter.

In theoretical terms, the Péclet number must be formulated in two dimensions in order to compare perpendicular convection and conduction fluxes such as those under the blanket, which is omitted here for the sake of clarity.

For the typical parameters and dimensions of large glass furnaces such as float glass furnaces, we find that the Péclet numbers are usually greater than 10. For clear or ultra-clear glass, the convection of the recirculation loop always has a dominant effect on the transport of heat under the lower surface of the blanket.

A small decrease in the recirculation flow rate, and therefore in the speed, does not change the mode of heat transfer under the blanket, which continues to be dominated by convection. However, a decrease in the recirculation flow rate reduces the heat flux in the blanket, Q_{blanket}^{low}. We now understand that a decrease in the recirculation flow rate and in the speed under the blanket reduces the value of both Q_{blanket}^{low} and the recirculation supply ΔQ_{rec}. Thus the heat balance is conserved.

A decrease in Q_{blanket}^{low} causes the blanket to be extended to a greater or lesser degree.

Any decrease in the heat supply on the lower surface Q_{blanket}^{low} must be compensated by an increase of the heat supply on the upper surface Q_{blanket}^{upp} in order to conserve the total energy Q_{blanket} required to melt the blanket. The power distribution of the burners can be adapted in order to reinforce the heat flux on the upper surface Q_{blanket}^{upp}. This reinforcement of the heat flux can be achieved by other means such as oxy-boosting or vertical impacting flames.

According to the invention, the furnace includes a means for slowing the flow rate of the primary recirculation loop. The two glass recirculation loops B1 and B2 are in hydrodynamic competition. The position of the separation region between the two loops depends on the ratio of their intensities. A decrease in the intensity of loop B1 causes the separation region to be displaced toward the furnace inlet, thus reducing the length C. In the case of a continuous casting furnace, the main glass flow creates a central upward flow region RC interposed in the separation region between the two recirculation loops B1 and B2. The reduction of the loop B1 causes the upward flow region RC to be displaced toward the furnace inlet. After the upward flow region, the main flow follows the path 4. The glass refining takes place in the first part of this path 4. If the refining temperature is maintained over an extended length L corresponding to the displacement of the upward flow position RC, the refining region is extended, thus improving the quality of the glass.

Preferably, the method used to slow the flow of the primary recirculation loop is that of decreasing the depth by means of successive steps which can be formed in a graduated way using a plurality of low steps 8, which generally have a height of less than 25 cm (FIG. 3).

In another exemplary embodiment shown in FIG. 3, the floor 7 is inclined continuously from the top to the bottom from the inlet E to a region located in the vicinity of the vertical line dropped from the end of the blanket T.

In another exemplary embodiment shown in FIG. 4, the floor remains horizontal up to a point below the inlet, and comprises one or more vertical projections 9, which may for example extend across its whole width. The projections 9 are preferably positioned under the blanket. However, care must be taken not to create a dead region or excessively cold region in the glass, in order to avoid any quality problems.

The steps 8 can be given chamfered nosings 8a if required, in order to reduce the effect of corrosion on the steps. Corrosion of the steps cannot adversely affect the quality, since the glass in contact with the floor in this region is subsequently forced to rise into the refining region by the central upward flow.

In the case of ultra-clear glass, the amount of thermal insulation of the floor is commonly reduced in order to reduce the floor temperature. The use of geometrical retardation according to the invention also increases ΔT to a greater or lesser extent, and consequently decreases the floor temperature. The combination of reduced insulation and geometrical retardation reduces, notably, the risk of corrosion of the floor refractories.

If the decrease in the heat supply to the lower surface of the blanket Q_{blanket}^{low} is found to be large, and if additional heating of the upper surface is insufficient to compensate for this, the blanket may become extended beyond the desired region.

In this case, heat must be supplied to the lower surface of the blanket, notably by means of conventional electrodes 10, in order to reinforce the heat exchange on the lower surface of the blanket.

According to the invention, the heat supply provided by the electrodes 10 is mainly intended to supplement the heat contributed by the convection of the glass, in order to maintain the value of Q_{blanket}^{low}.

In this case, the electrical heating reinforcement provided by the electrodes 10 serves to supplement the heat supply to the lower surface.

Q_{blanket}^{low}=ΔQ_{rec}+Qₑₗ

Thus the energy supply provided by electrical boosting immediately under the blanket enables the extension of the blanket to be limited.

Advantageously, provision is made for electrical heating or reinforcing “boosting” in the furnace, in the proximity of the charging end E, for example at the first steps 8, using at least two electrodes 10 installed vertically on two steps of the floor. The electric current flows from one electrode to the other through the molten glass, thus heating the glass. A local flow is established around the electrodes. This has the effect of reinforcing the heat exchange with the blanket. The global flow of the recirculation loop B1 continues to be dominant under the blanket.

According to the invention, the inclined floor, notably with multiple steps 8, makes it possible to have:
a floor whose construction and heating can be controlled by maintaining the direct mechanical connections between the refractory blocks to exert a horizontal thrust which is required in order to seal the joints,
little risk of corrosion.

FIG. 5 shows another exemplary embodiment of the invention, based on a new heat balance equilibrium of the loop B1.

It is characterized in that the slowing of the flow in the primary recirculation loop is achieved by a supply of heat to the return glass flowing at the floor level. The heat supply in this variant embodiment is advantageously combined with a reduction in the floor depth.

The recirculation of the loop B1 is created by the natural convection, or heat engine, produced by a differential between the mean temperature of the glass under the blanket and that of the upward flow region R1.

If the temperature of the glass is raised after it has been cooled by the blanket, by means of a localized heat supply, the temperature differential is reduced, thus reducing the strength of the heat engine of the recirculation loop B1.

The glass temperature at the floor therefore has an effect on the hydrodynamic competition of the two recirculation loops B1 and B2 and the position of the central upward flow RC. Thus hotter glass at the floor enables the extent of the recirculation loop B1 to be reduced.

The reduction in the recirculation flow can only be achieved if the reduction of the viscosity of the glass, due to an increase in temperature in the return flow, remains low and has little effect on the frictional resistance to the flow of glass. For ultra-clear glass and the proposed temperature rise, the variation in the viscosity of the glass is relatively small, thus enabling the recirculation flow rate B1 to be reduced effectively.

As shown in FIG. 5, the heat supply is localized in the return glass above the floor.

The heat supply can be provided, notably, by means of horizontally installed electrodes 11. The electrodes can also be installed vertically, but with limited height.

When installing the electrodes, it is important to ensure that no hot spots are created in the glass, in order to avoid the creation of an excessively powerful vertical heat engine, by maintaining a good distribution of the electrical field among the electrodes.

Advantageously, the heat supply according to the invention is approximately 10% of the recirculation energy ΔQ_{rec}, which also corresponds to the energy absorption of the lower surface of the blanket.

Thus, for a float glass furnace with an output of 400 t/day, the heat supply will be approximately 0.5 MW. It will be distributed among about ten electrodes.

This solution according to the invention is useful, notably, if the floor is made from refractories having very good corrosion resistance, because of the small increase in the floor temperature.

If the heat transfer Q_{blanket}^{low} is weakened by the reduction of the recirculation loop, the heat supply is reinforced on the upper surface of the blanket so as to maintain the length of the blanket.

The mean depth h of glass under the first recirculation loop can be at least 5% less than the depth in the upward flow region RC of the glass.

Electrical heating using electrodes 10 is provided in the glass bath in order to reinforce the heat exchange on the lower surface of the blanket, and/or a supplementary heat supply is provided on the upper surface of the blanket T.

The means X for slowing the recirculation flow rate according to the invention, creating a reduction in the speed of the glass under the blanket T, can be provided in various ways, for example:
by reducing the depth of the furnace in the primary loop region;
by reducing the depth of the furnace under the blanket T only;
by using one or more projections 9 on the floor in the primary loop region;
by means of a heat supply to the return glass above the floor.

For ordinary or clear glass, but notably for ultra-clear glass, the solution according to the invention provides:
a reduced recirculation flow rate of the primary loop B1;
a reduction in the extent C of this loop, in favor of the secondary loop B2;
maintenance or prolongation of the refining time in the secondary loop B2.

1-10. (canceled)

11. A glass furnace for heating and melting materials to be vitrified, comprising:
an inlet (E) for the raw materials,
a superstructure (R) provided with heating means (G),
a tank (M) containing a bath of molten glass on which a blanket (T) of raw materials floats from the inlet to a point a certain distance away inside the furnace,
an outlet (Y) through which the molten glass is discharged,
a primary molten glass recirculation loop (B1) and a secondary molten glass recirculation loop (B2) formed in the bath (N) between a hotter central region (I) of the furnace and, respectively, the inlet and the outlet, which are at a lower temperature, and
a means (X) for slowing the flow rate of the molten glass in the primary recirculation loop (B1), the means for slowing being configured to reduce the extent (C) of the primary recirculation loop.

12. The furnace as claimed in claim 11, wherein the means for slowing the flow rate in the primary recirculation loop comprises a reduction in the mean depth (h) of the glass under the recirculation loop relative to the depth in the central upward flow region (RC) of the glass.

13. The furnace as calimed in claim 11, wherein the means for slowing the flow rate in the primary recirculation loop comprises an inclination (7) of the floor (S) extending substantially from the inlet (E) toward the interior of the furnace, over a distance of 20-100%, and preferably 50%, of the extent (C) of the primary recirculation loop (B1), in such a way that the depth of the floor increases from the furnace inlet toward the interior.

14. The furnace as claimed in claim 12, wherein the reduction in the mean depth (h) is provided in a discontinuous way.

15. The furnace as claimed in claim 13, wherein the inclination of the floor (S) is provided by means of successive steps.

16. The furnace as claimed in claim 15, wherein the height of each step (8) is less than 25 cm.

17. The furnace as claimed in claim 15, wherein the nosings (8a) of the steps (8) are chamfered.

18. The furnace as claimed in claim 11, wherein the mean depth (h) of glass under the first recirculation loop is at least 5% smaller than the depth in the upward flow region (RC) of the glass.

19. The furnace as claimed in claim 11, wherein electrical heating using electrodes (10) is provided in the glass bath in order to reinforce the heat exchange on the lower surface of the blanket, and/or a supplementary heat supply is provided on the upper surface of the blanket (T).

20. The furnace as claimed in claim 11, wherein the means for slowing the flow rate in the primary recirculation loop comprises a means for the supply of heat to the return glass flowing at the floor level.
